(19) United States
(12) Patent Application Publication
(10) Pub. No.: US 2009/0296903 A1
(43) Pub. Date: Dec. 3, 2009

(54) Method and System for Automatic Directory Entry for Telecommunications Devices

(75) Inventors: Andrew A. Lippman, Salem, MA (US); Nalin Mistry, Ottawa (CA)

Correspondence Address: GUERIN & RODRIGUEZ, LLP, 5 MOUNT ROYAL AVENUE, MOUNT ROYAL OFFICE PARK, MARLBOROUGH, MA, 01752, US

(73) Assignee: Nortel Networks Limited, St. Laurent (CA)

(21) Appl. No.: 12/129,373

(22) Filed: May 29, 2008

(51) Int. Cl. H04M 11/00

(52) U.S. Cl. 379/93.23

(57) ABSTRACT

Described is a method for entry of information into a directory accessible to a caller telecommunications device. Information associated with a called telecommunications device is transmitted from the called telecommunications device over an auxiliary communication channel to a caller telecommunications device. The information is sent in response to an initiation of a communication, such as a voice communication, between the devices over a primary communication channel. An inquiry is presented to a user of the caller telecommunications device to determine if the received information is to be stored. If the user responds affirmatively, the information is stored in a directory in the caller telecommunications device or in a directory on a remote server accessible to the caller telecommunications device. In other embodiments one or more additional auxiliary communications channels are used to transmit or retrieve the information.

### FIELD OF THE INVENTION

The invention relates generally to the use of auxiliary data associated with a communications session such as a telephone call. More particularly, the invention relates to how such data are automatically generated and communicated by a called telecommunications device and used by a telecommunications device that initiates the communications session.

### BACKGROUND OF THE INVENTION

Telephones are widely used for business and personal communications. Telephone communications were originally limited to wired configurations and telephones had limited functionality that typically included only the ability to dial a number and to receive a call from another wired telephone on the network. The introduction of mobile phones enabled users to make and receive telephone calls over greater areas as long as the user was within the range of a base station. The base station often was owned by the user's mobile operator or some other operators in cases where number portability is available. Users realized increased mobility from the introduction of cellular phones. Public adoption of cell phones increased dramatically as cellular coverage increased, cell phone technology advanced and cell phones decreased in size.

Today most telephones have functionality well beyond their ability to initiate or receive voice communications. For example, many telephones include a contact directory which indicates a name or telephone number. Names and corresponding telephone numbers are typically added to a contact directory by the user by entering alphanumeric characters via a keypad on the telephone. Many telephones also maintain a list of called telephone numbers and a list of telephone numbers associated with received calls. If a user wants to place a call, the user typically selects the desired telephone number from one of the lists and then initiates the call by depressing a “call button.”

The convenience of making a telephone call using a telephone number stored in a contact directory often presents problems for the user. For example, if a significant time has passed since the call was made or received, the user may view the corresponding telephone number and not recognize or remember the person or business associated with that number. It may be possible that the user may not remember the original call even if a name is stored with the number. In other instances, the telephone may have limited capacity to store numbers so that the user may only want to store frequently called telephone numbers in the directory or the user may simply want to maintain an uncluttered directory. In still other instances, a caller may seek information regarding the called person or business but the information may not be readily obtained and may depend on whether or not an individual is available to answer the call.

The present invention addresses the needs identified above and provides additional advantages.

### SUMMARY OF THE INVENTION

In one aspect, the invention features a method for entry of information into a directory of a caller telecommunications device. Information is transmitted from a called telecommunications device over a first communication channel and received at the caller telecommunications device. The information is associated with the called telecommunications device and is transmitted in response to an initiation of a communication between the caller telecommunications device and the called telecommunications device over a second communication channel. An inquiry is presented to a user of the caller telecommunication device to determine if the received information is to be stored in the directory of the caller telecommunications device. The information is stored in the directory of the caller telecommunications device based on a response of the user to the inquiry.

In another aspect, the invention features a method for providing content from a called telecommunications device to a caller telecommunications device. A communication initiated by a caller telecommunications device and established over a first communication channel is received and caller information that is associated with the caller telecommunications device and transmitted over a second communication channel is also received. An information set to send to the caller telecommunications device is selected from a plurality of information sets based on the caller information. The selected information set is sent to the caller telecommunications device over the second communication channel

In yet another aspect, the invention features a method for providing content from a called telecommunications device to a caller telecommunications device. A communication initiated by a caller telecommunications device and established over a first communication channel is received. Caller information that is associated with the caller telecommunications device and transmitted over a second communication channel is also received. An information set to send to the caller telecommunications device is selected from a plurality of information sets based on the caller information. The selected information set is sent to a server over a third communication channel. The server stores the selected information in a directory accessible to the caller telecommunications device.

In still another aspect, the invention features a method for automatic execution of a task on a caller telecommunications device. An information set is transmitted from a called telecommunications device over a first communication channel to the caller telecommunications device. The caller telecommunications device is in communication with the called telecommunications device over a second communication channel. The transmitted information set is received at the caller telecommunications device and a task is initiated on the caller telecommunications device in response to the transmitted information set.

### BRIEF DESCRIPTION OF THE DRAWINGS

The above and further advantages of this invention may be better understood by referring to the following description in conjunction with the accompanying drawings, in which like numerals indicate like structural elements and features in the various figures. For clarity, not every element may be labeled in every figure. The drawings are not necessarily to scale, emphasis instead being placed upon illustrating the principles of the invention.

FIG. 1 is a flowchart representation of an embodiment of a method for entry of information into a directory of a caller telecommunications device according to the invention.

FIG. 2 illustrates a communications environment in which the method of FIG. 1 can be practiced.

FIG. 3 illustrates another communications environment in which entry of information into a directory of a caller telecommunications device according to the invention can be practiced.

FIG. 4 shows an alternative communications environment to that depicted in FIG. 3 where reverse caller ID information is transmitted from the called device to a directory server.

FIG. 5 illustrates caller telecommunications devices in communication with a called telecommunications system according to an embodiment of the invention.

FIG. 6 is a flowchart representation of an embodiment of a process in which a customized information set is provided to a caller device according to the invention.

FIG. 7 depicts an alternative arrangement to the configuration of FIG. 5, where various information sets are stored in the memory of an information server.

FIG. 8 shows an alternative configuration to that shown in FIG. 7, where limited data that are responsive to the respective phone calls are sent to the caller devices instead of the information server.

FIG. 9 is a flowchart representation of an embodiment of a method for automatic execution of an application program on a caller telecommunications device according to the invention.

### DETAILED DESCRIPTION

In brief overview, the invention relates to methods for entry of information into a directory accessible to a caller telecommunications device as described below. The methods allow for the automatic population of a directory with information relating to a called telecommunications device. The directory can be maintained on the caller telecommunications device or on a server accessible to the caller telecommunications device.

Historically, a voice telephone communication (hereinafter a telephone “call”) is made by dialing a telephone number that is associated with a called telecommunications device, that is, the device that receives the call. As used herein, a telecommunications device means any device that can initiate a communications session during which data such as voice data, text, images or combinations of data types are sent to and received from a different telecommunications device. Telecommunications devices include, by way of example, landline telephones (e.g., conventional desk phone, cordless phones and the like), Internet telephones and mobile telephones (e.g., wireless phones). The principles of the invention as set forth below are generally described with respect to telephones (or “phones”) but it should be recognized that the invention also contemplates other varieties of telecommunications devices such as personal digital assistants (PDAs) and handheld and laptop computers.

Telephones have evolved significantly over time so that many commercially available telephones now include a storage capability that permits a registry of telephone numbers and the people or businesses associated with the telephone numbers. The registry is often referred to as a directory or contact list. In modern mobile telephones, the directory can contain additional information such as residential addresses, email addresses, and additional telephone numbers and identifiers for the listed people and businesses. Some directories also permit an image to be associated with the person or business.

Directories can be searched in a variety of ways including by scrolling through the entries in the directory or by entering an identifier of the party to be called either in whole or in part. For example, some mobile telephones permit a user to retrieve a desired entry in the directory by entering through the telephone keypad one or more letters of the corresponding name or identifier. The telephone then displays a subset of the entries in the directory that includes only those entries that begin with the entered letters. The user then scrolls through the displayed entries and can select one of the entries to initiate a call without the need to enter any of the digits in the associated telephone number. In another example, some mobile telephones permit a user to speak the identifier for the party to be called. The spoken identifier is then “translated to text data” to enable a search of the directory. Once the identifier is found, the associated telephone number is automatically dialed without any further action required by the user.

A directory can be entered into a telephone by a user, for example, the owner of the telephone, or the directory can often be created automatically. Some telephone service providers retrieve and store the directory from a customer telephone for convenience. The stored directory can later be automatically loaded into a telephone that the customer purchases, rents or otherwise obtains. Some telephones store the directory on a removable device that may also store customer authorization information. In this case, a user may install the removable device in a number of different mobile telephones or portable devices to thereby gain access to both telephone services and the entries in the directory. One example of a removable device for this purpose is a subscriber identity module (SIM) chip that complies with the Global System for Mobile Communications (GSM) standard. The directory can also be stored on storage devices that are separate and independent of the SIM chip.

Some telephones and mobile devices include an electrical cable or an ancillary radios that permit connection to a computer. Examples include devices having a universal serial bus (USB) cable or Bluetooth capability. Through the connection, data in the directory can be stored on a user's computer, edited by the user on the computer and loaded from the computer into the telephone. Editing in this manner is often more convenient that performing editing directly at the telephone due in part to the typically smaller dimensions of the telephone keypad and display, and because the computer a more user-friendly editing or entry manipulation program may be available on the computer.

Many commercially-available telephones today provide “logs” of telephone calls made or received by the device. The call logs can be long lists or may only maintain information for the most recent calls. In addition, the call logs can indicate whether the call was an incoming call, a previously attempted call, whether or not the call was completed, and can include other information such as the time of day the call was made and the duration of the call.

One use of a call log is to simplify repeated calling of a party. For example, many telephones permit re-dialing the most recent call in the call log using a single keystroke. Redialing can also be accomplished by scrolling through the entries displayed for the call log and selecting a particular entry, thereby avoiding the need to re-enter the full telephone number. In some instances a user may use the call log to avoid the inconvenience of opening or otherwise searching the directory for the same telephone number.

Often the software in the telephone automatically enters the name of the party that has called or has been called into the call log. This process is facilitated by two aspects of telephone systems. First, when a user initiates a communication on a telephone, the telephone system transmits information relating to the calling party as part of the establishment of a connection between the calling telephone and the called telephone. This service, typically referred to as “caller ID,” has been available for many years for both residential and business users. The caller ID information can include the name as well as the telephone number of the caller device. Users often use the information when receiving a call to determine who is calling and therefore whether to answer the call. This determination is frequently referred to as “screening a call.” The second aspect relates to the use by some telephones to search the directory in order to display the name of the calling party in addition to (or in place of) their telephone number. For example, a user can have an entry in a directory that includes their home telephone number and the title “HOME.” When a call is initiated by the user's home telephone, the receiving telephone presents the word “HOME” on the telephone display. Some telephones also include the ability to speak the word “HOME” so that the user can recognize the calling party without referencing the display. The displayed name is not required to be the actual name of the calling party as might be listed in a published telephone directory. Instead, the displayed name can be any reference to be associated with the telephone number and stored in the directory such as a colloquial or personalized reference.

One feature of a caller ID system is that the caller ID information can be disabled by the calling party. This option allows the calling party to make a call without revealing the name of the calling party or the telephone number associated with the caller telephone. Caller ID disablement is often utilized by people or organizations that automatically or repeatedly dial telephone numbers using telephones that are configured for outgoing calls only.

Another common attribute of many telephones is an expedited means to enter telephone numbers into the directory. When a user enters a telephone number directly that can be used for later dialing, the user can add other contact information such as the name of the party associated with the telephone number to be saved along with the telephone number. Similarly, when a user receives a call, the user can enter the telephone number for the calling device into the directory without the need to re-enter the number manually. The user only needs to edit an entry in the directory and associate the calling party's telephone number with that entry or the user can create a new name by which to identify the telephone number.

Based on the capabilities described above, the need to make a call by manually enter telephone numbers using a keypad has been substantially reduced. Eventually the use of traditional telephone numbers may be virtually eliminated at least from the perspective of a typical telephone user, although the use of a telephone number may still be employed at a level that is transparent to the user. The capabilities are similar to those available with electronic mail (“email”) systems in use today. Email addresses often are rapidly and automatically entered into email personal address books after their first use in a sent or received email. After a user enters the first few characters of an email address that is stored in the personal address book into a newly composed email before sending, an application operating on the email client often automatically completes the email address by filling in the remainder of the email address. In some instances, if an insufficient number of characters have been entered to unambiguously determine the complete email address, a short list of addresses matching the entered letters is presented to the user.

The existence of information related to a telephone call that originates at the caller device, at the called device or at one or more intermediate points used to establish the communications session between the caller and called devices is accommodated in existing conventional telephone systems (landline or mobile) and existing voice over Internet Protocol (VOIP) systems. In landline systems, caller ID information is typically generated by the telephone carrier at a central office. The caller ID information is generally sent during an initial period when the call is established. In typical residential telephone systems, caller ID data are sent between the first and second ring signals. In digital systems such as office phone systems and communications between telephone carrier sites, or in Integrated Services Digital Network (ISDN) telephone systems, the caller ID information can be carried as an additional signal within the telephone call. Such systems support the inclusion of data that are not related to voice communications along with the voice data.

Some office telephone systems called Private Branch Exchanges (PBXs) provide for sending information about the party being called back to the caller device. For example, the dialed number can be indicated on a telephone display. If the call is transferred to a telephone different from the dialed telephone (such as when the dialed telephone is busy), a telephone number corresponding to the telephone receiving the transferred call is then displayed. Thus the caller knows that the call has been transferred. In many VOIP systems, Session Initiation Protocol (SIP) is used to establish a connection between the caller device and the called device. The protocol provides for the bidirectional communication of information between the devices that can indicate the type of voice coder to be used by each device and identification data. The information can originate at the caller device or called device, or the information can be inserted by proxy devices disposed between the caller device and the called device.

Mobile telephone systems use a digital channel that is associated with information used to control mobile devices and to establish telephone calls. This additional digital channel is sometimes used to accommodate Short Message Service (SMS) communications such as text messages or messages to a user regarding availability of service or account information. Text messages can be generated by a user by entering text using a device keypad or by a user through a keyboard at an Internet terminal. For example, some services allow a user to address an email to a user of a mobile telephone by including the telephone number of the telephone as part of an email address. Other mobile electronics devices that serve as “portable digital assistants” such as a BlackBerry® and iPhone® have multiple communications paths available and therefore permit simultaneous communications such as concurrent voice and data communications.

The systems described are not always convenient for directory management. More specifically, the systems do not provide for automatic entry of a new contact into a directory. For example, when a caller places a call to a restaurant for the first time, the caller determines the phone number using a printed or displayed telephone directory such as a phone book or online directory webpage. The caller then enters the digits for the telephone number manually using a keypad on the telecommunications device. Subsequently, the “dialed number” appears in a log of attempted calls only as digits as there is no other information yet entered by which the call can be identified. If the caller wishes to save the dialed number for later use, the number can be left in the log or stored in the directory. The caller then manually provides textual information, such as the restaurant name, to be stored and associated with the telephone number to aid the caller in recognition and retrieval at a later time.

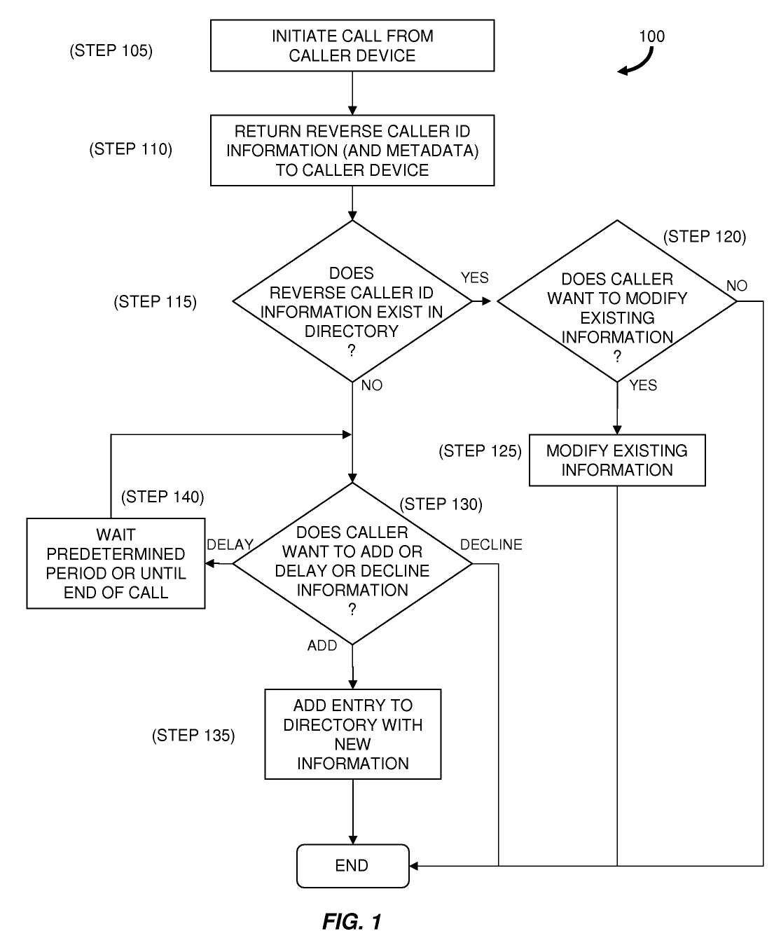

FIG. 1 is a flowchart of an embodiment of a method 100 for entry of information into a caller directory according to the invention and FIG. 2 illustrates a communications environment in which the method 100 can be practiced. A caller telecommunications device 10 (e.g., a wireless phone) initiates (step 105) a telephone call to a called telecommunications device 14 over a voice communications channel 18. Regardless of whether the call is answered or not, the called device 14 utilizes a second communications channel, that is, an auxiliary data channel 22, to send (step 110) information to the caller device 10. The information that is returned to the caller device 10 is similar to conventional caller ID information sent at the initiation of a call with two significant distinctions. First, the information includes identification of the called device 14 by a representative name, an associated telephone number or both name and telephone number. Second, the information is sent from (or on behalf of) the called device 14 to the caller device 10 instead of being sent from (or on behalf of) the caller device 10 to the called device 14. Thus the information can be referred to as “reverse caller ID” or “connected ID” information. Although the reverse caller ID information is shown as being sourced directly from the called telecommunications device, in other embodiments the information is inserted into the auxiliary data channel by a proxy device. For example, the information can be inserted via a local exchange in a public switched telephone network (PSTN) or via a private branch exchange (PBX). In other embodiments described in more detail below, the returned information includes additional information, or metadata, that relates to the called device 14 or is associated with the intent or purpose of the telephone call.

Upon receipt of the reverse caller ID information at the caller device 10, an application executing on the caller device 10 determines (step 115) whether the reverse caller ID information is stored in the directory 30. If the information is already stored, an inquiry is presented to the user to determine (step 120) whether or not to modify the corresponding information stored in the directory 30 and a modification to the information is performed (step 125), if appropriate. If it is determined in step 115 that the reversed caller ID was not already stored in the directory 30, the user is prompted to determine (step 130) whether or not to add the received information to the directory 30 or if the user wants to delay the decision on adding the information. The telephone number and new information is added (step 135) to the directory if the user responds affirmatively. If the user elects to delay the decision, the user is prompted again after expiration of a preset time or when the call is terminated (step 140). The user may repeatedly elect to delay in the event the user is engaged in a voice conversation or distracting activity, and does not wish to commit to a decision.

Inquiries and user prompts can be presented to the user in various forms. For example, the caller device 10 can display prompts, generate an audible prompt or speak the prompt. The user conveniently responds to the prompt by entering a response via a device keypad with one or more keystrokes or, if the device has voice recognition capability, the user may speak a response, for example, by saying “YES”, “NO”, “ADD”, “WAIT” or “CHANGE”.

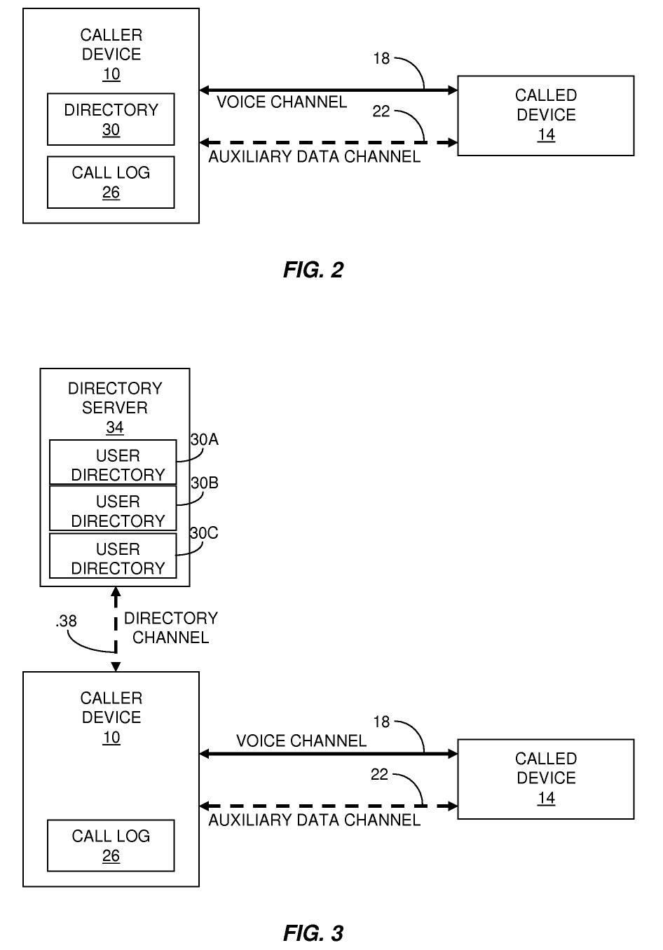

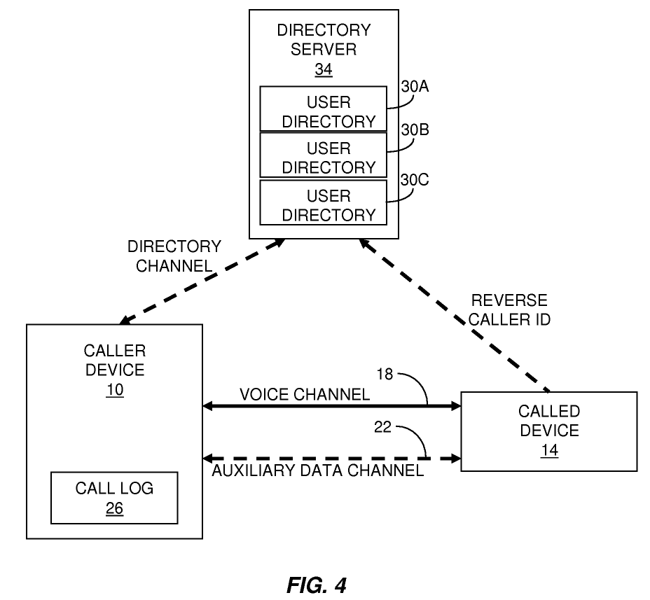

FIG. 3 illustrates another communications environment in which entry of information into a caller directory according to the invention can be practiced. The user's directory is not maintained on the caller telecommunications device 10 but is instead stored on a directory server 34 accessible to the user. The directory server 34 may store multiple directories 30A, 30B and 30C (generally 30, only three are shown for clarity) for a number of different users. Reverse caller ID information received by the caller device 10 is “forwarded” to the server 34 and stored in the corresponding directory 30. Advantageously, each user is able to access and manage their own directory 30 using any number of telecommunications devices. For example, a user can access and manage a single “remote directory” 30 using a wireless phone, a handheld personal digital assistant, a personal computer and the like without the need to perform local synchronizations between the devices. Each telecommunications device can access the user's directory 30 through a directory communications channel 38 which may be established, for example, via the Internet using a uniform resource locator (URL) associated with the directory server 34.

FIG. 4 shows a communications environment similar to that depicted in FIG. 3 except that the reverse caller ID information is transmitted from the called device 14 (or a proxy acting on behalf of the called device) to the directory server 34. In this environment the caller device 10 has access and management ability for the directory 30; however, the caller device 10 is not involved in routing the reverse caller ID information to the server 34. For example, the caller device 10 forwards information (e.g., a server URL) to the called device 14 over the auxiliary data channel 22 to enable the called device 14 to send the reverse caller ID information to the server 34.

According to other embodiments of the method of the invention, the auxiliary data channel can also be used to provide metadata to augment the utility of a telephone call. The metadata includes additional data that relate to the data present in the main body of a communication between the caller device 10 and the called device 14. In the example described above where a user calls a restaurant, the metadata can be sent to the caller device 10 in combination with the reverse caller ID information. The additional information can be presented to the user on the display of the caller telecommunications device 10 and can include, for example, location information for the restaurant or a confirmation for a requested dinner reservation.

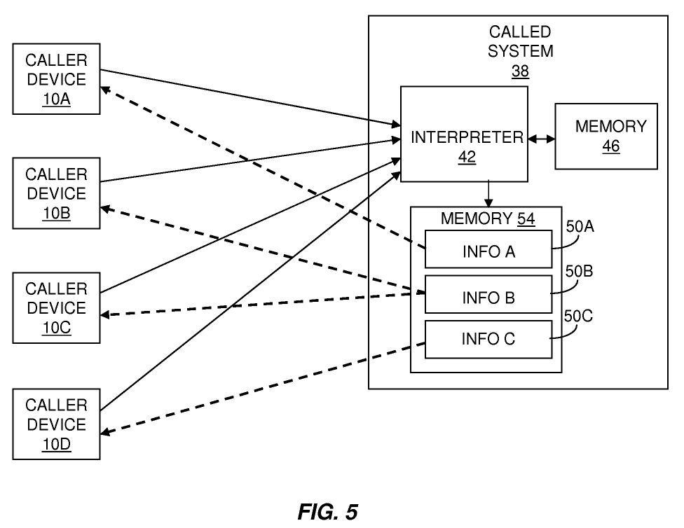

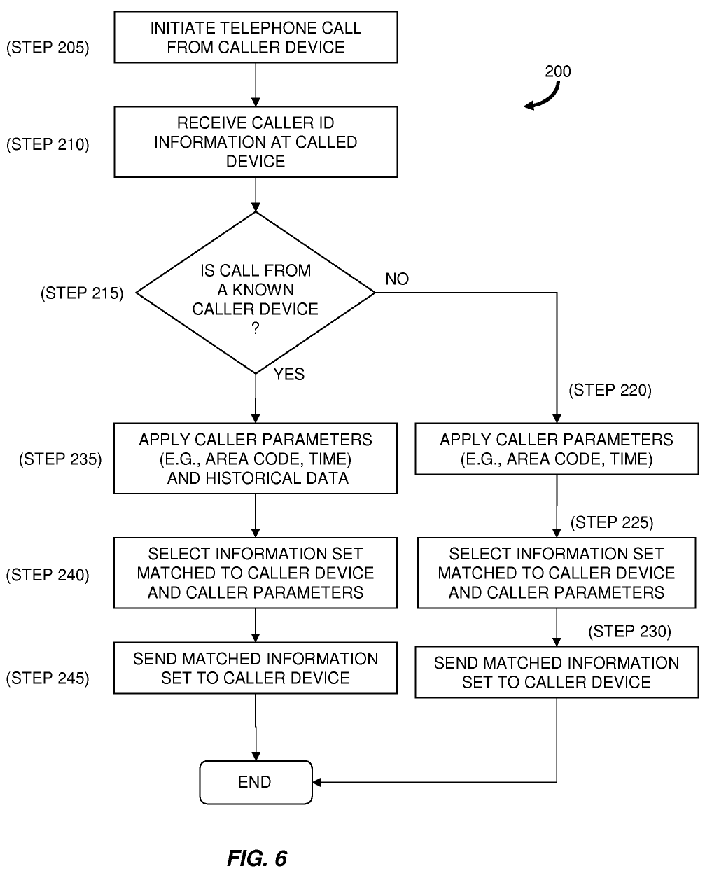

FIG. 5 illustrates caller telecommunications devices 10A to 10D (generally 10) that communicate with a called telecommunications system 38. Each caller device 10 is identified to the called system 38 by caller ID information. The called telecommunications system 38 includes an interpreter module 42 instantiated as a hardware processor in communication with a memory module 46. The interpreter module 42 receives caller ID information over auxiliary communications channel in tandem with incoming phone calls from the caller devices 10. The memory module 46 stores caller ID information for each incoming call, including the telephone number and name associated with each calling device 10 and other parameters such as the date and time that each call is received. In one option, the memory module 42 also stores category information relating to the call. Category information indicates the purpose of a call, such as the intent to make a reservation or to request product information. In one embodiment, category information is determined by prompting the caller to categorize the call. For example, the caller can be prompted to identify the call as a request for general information, for directions, for account information and the like. The appropriate keystroke or spoken response is provided by the caller.

Depending on the caller ID information or a combination of caller ID information and other known information (e.g., category information and historical call information), the interpreter module 42 determines which information set “INFO A” 50A, “INFO B” 50B or “INFO C” 50C (generally 50) stored in memory module 54 is most relevant to a particular caller device 10 and therefore is to be sent via the auxiliary data channel to that caller device 10. The information sets 50 contemplated according to the invention can include various types of metadata. For example, an information set can include welcome information that includes a business address and hours of operation for a business associated with the called telecommunications system 38. Other examples of information sets include restaurant menus, product information and reservation information.

FIG. 6 is a flowchart representation of an exemplary process 200 in which a customized information set is provided to a caller device 10 according to the invention. Referring again to the restaurant example described above and to FIGS. 5 and 6, a first-time caller initiates (step 205) a call from a caller telecommunications device 10 to a restaurant. A called telecommunications system 38 associated with the restaurant receives (step 210) the call and determines (step 215) if the call is being placed by a known caller device. The determination can be made by comparing the telephone number with the entries for previously received calls that are stored in the memory module 46.

If the number is not recognized, that is, if the call is from a new caller, caller parameters (e.g., the area code associated with the caller device 10) are examined (step 220) to determine (step 225) the appropriate information set to send. Subsequently, the “matched information set” is sent (step 230) to the caller device 10 over the auxiliary data channel. For example, welcome information that includes hours of operation and location information can be sent along with the restaurant's name and telephone number.

If the call is from a recognized caller device 10, caller parameters are also examined (step 235) to determine (step 240) and send (step 245) the appropriate information set. In this second process path, caller parameters can also include historical data that track the date and time when previous calls were received from this caller device 10. For example, the called system 38 may recognize the caller ID information of the caller device 10 as matching a recent call having a category indicating that the user requested reservation information. In such an instance, metadata confirming a specific reservation time is sent back to the caller device 10 over the auxiliary data channel. Alternatively, the confirmation metadata may be “pushed” to the caller device 10 at a later time over an auxiliary data channel without requiring a subsequent phone call to be initiated by the caller device 10.

In another example, a user may dial an “800 number” to obtain specific product information. In this example, the interpreter module 42 associated with the called system 38 can examine the area code in the caller ID information to determine a particular information set to return to the caller device 10. The information set can include the appropriate local contact information for the caller and may also be provided in the predominant language associated with the area code.

The process 200 shown in FIG. 6 and described above is a limited example of how different information sets may be selected. It should be recognized that a wide range of caller parameters, including category information and historical information, available to the called device 14 or system 38 may be examined and accorded equal or different weights in determining which information set to send.

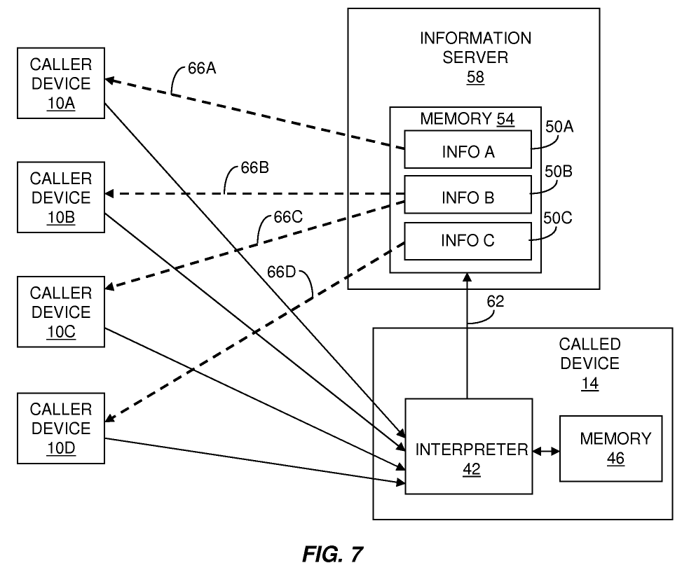

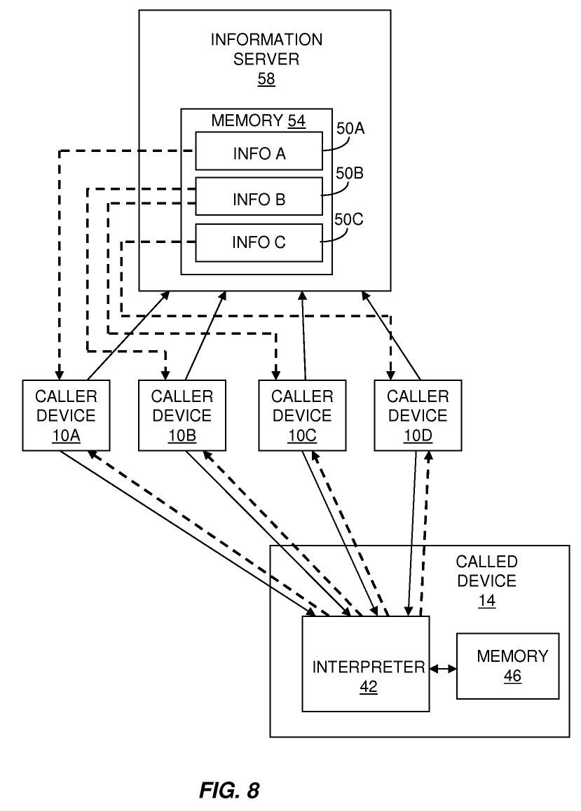

FIG. 7 depicts an alternative arrangement of the configuration of FIG. 5 where various information sets 50 are stored in memory 54 of an information server 58. As illustrated, the server 58 is remotely located from the called telecommunications device 14. Advantageously, the called device 14 transmits limited data to the server 58 sufficient to identify the proper information set 50 to be sent and to identify the caller device 10 to receive the information. A server communications channel 62 is established between the called device 14 and the information server 58 over which the additional information is transmitted, thus overcoming potential bandwidth limitations with the auxiliary data channel established between a caller device 10 and the called device 14. The information server 58 distributes the information sets over separate auxiliary data channels 66A to 66D established independently for each caller device 10A to 10D, respectively. For example, if the caller telecommunications device includes a web browser, the separate auxiliary communications channel can be established with the information server 58 through the Internet.

FIG. 8 shows an alternative configuration to that shown in FIG. 7. As described above, caller ID information and other caller parameters are used to determine which information set 50 to send to each caller device 10; however, the limited data that are responsive to the respective phone calls are sent to the caller devices 10 instead of the information server 58. The limited data sent to a particular caller device 10 are accompanied by a link used to establish a connection between the caller device 10 and the information server 58. For example, the link may include the URL of the server 58 and data that identify which one of the stored information sets 50 is to be sent.

In another aspect the invention features a method of automatic execution of a task associated with the content of a communications session. The method is an extension of the capabilities described above where additional information accompanying the reverse caller ID information is presented to a user. The additional information is sent from a caller telecommunications device 14 or system 38 in a format that is provided directly or in modified form to an application resident on the caller device 10.

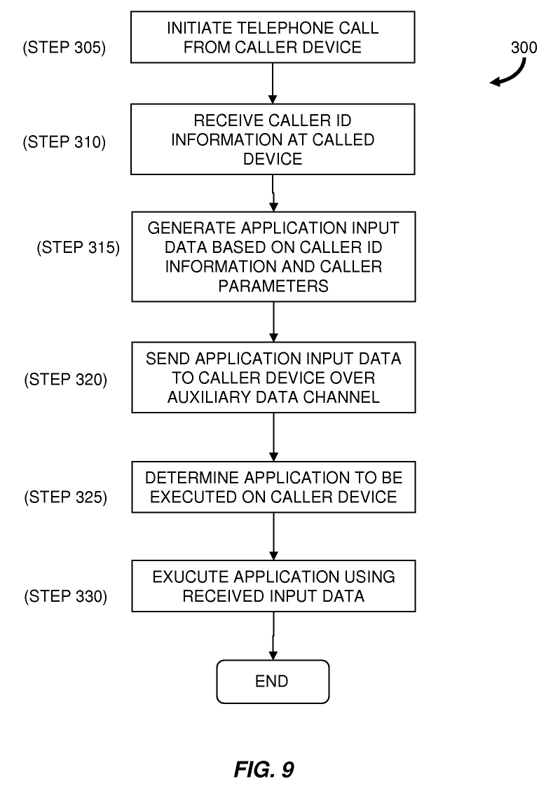

FIG. 9 is a flowchart representation of an embodiment of a method 300 for automatic execution of an application program on a caller telecommunications device according to the invention. A user of the caller telecommunications device initiates (step 305) a telephone call with a called telecommunications device. Caller ID information is received (step 310) is received at the called device and can be used as described above to determine information to be returned to the caller device over an auxiliary communications channel. However, the information is generated (step 315) in the form of input data that can be utilized by an application or software program resident on the caller device. The application input data are sent (step 320) to the caller device over the auxiliary communications channel. Upon receipt of the input data, the caller device determines (step 325) the appropriate application or software program to process the input data.

In one embodiment, the application provides a visual display to the user. For example, the data processed by the application may be coordinates that are interpreted and displayed by a mapping program in the form of a map indicating a specific location. Alternatively, the coordinates may be used by a navigation program to provide textual, graphical and/or spoken information to assist the user in traveling to the location. Advantageously, businesses such as the restaurant described above can easily provide potential customers with directions to their business locations.

Other types of applications are also contemplated for processing the input data on the caller telecommunications device. For example, the application program can be a calendar or appointment program which maintains appointments and personal tasks for a user. In this example, the data received by the caller device over the auxiliary communications channel can include a business name, a contact name and a date and time for a meeting. The data are processed by the calendar program and automatically entered into the user's calendar without any user interaction. The user can then see the scheduled appointment with other relevant information and may receive audible and visual notifications as the appointment time approaches.

Although some of the embodiments described above relate to telephone devices and voice communications, it should be noted that the caller telecommunications device and the called telecommunications device can be other forms of telecommunications devices and that the method can be applied using alternative forms of communications such as instant messaging and email. For example, auxiliary data similar to the reverse caller ID information can be transmitted over a separate communications channel that is either physically or logically distinct from the main communications data. In the case of email, a modified email message format can be used such that the reverse caller ID data are contained in the email data but maintained separate from the email header fields and body text. Alternatively, the reverse caller ID data are provided in a separate message that is received by the caller telecommunications device but not processed by the email client as a conventional email message.

While the invention has been shown and described with reference to specific embodiments, it should be understood by those skilled in the art that various changes in form and detail may be made therein without departing from the spirit and scope of the invention as recited in the accompanying claims.

What is claimed is:

1. A method for entry of information into a directory of a caller telecommunications device, the method comprising:
receiving at the caller telecommunications device information that is transmitted over a first communication channel from a called telecommunications device, the information being associated with the called telecommunications device and being transmitted in response to an initiation of a communication between the caller telecommunications device and the called telecommunications device over a second communication channel;
presenting an inquiry to a user of the caller telecommunication device to determine if the received information is to be stored in the directory of the caller telecommunications device; and
storing the information in the directory of the caller telecommunications device based on a response of the user to the inquiry.

2. The method of claim 1 wherein the inquiry is presented on a display of the caller telecommunications device.

3. The method of claim 1 wherein the inquiry is an audible prompt issued by the caller telecommunications device.

4. The method of claim 1 wherein storing the information in the directory comprises deleting at least a portion of previously-stored information associated with the called telecommunications device.

5. The method of claim 1 wherein the information comprises a telephone number for the called telecommunications device.

6. The method of claim 1 wherein the information comprises a name representative of the called telecommunications device.

7. The method of claim 1 wherein the communication between the caller telecommunications device and the called telecommunications device is a voice communication.

8. A method for providing content from a called telecommunications device to a caller telecommunications device, the method comprising:
receiving a communication initiated by a caller telecommunications device and established over a first communication channel;
receiving caller information that is associated with the caller telecommunications device and transmitted over a second communication channel;
selecting an information set from a plurality of information sets to send to the caller telecommunications device based on the caller information; and
sending the selected information set to the caller telecommunications device over the second communication channel.

9. The method of claim 8 wherein the selection of the information set is based on historical caller information.

10. The method of claim 8 wherein the caller information comprises at least a portion of a telephone number for the caller telecommunications device.

11. The method of claim 8 wherein the communication initiated by the caller telecommunications device and established over the first communication channel is a voice communication.

12. The method of claim 8 further comprising:
receiving the selected information set at the caller telecommunications device;
sending at least a portion of the selected information set from the caller telecommunications device to a directory server; and
storing the selected information sent from the caller telecommunications device at the directory server.

13. A method for providing content from a called telecommunications device to a caller telecommunications device, the method comprising:
receiving a communication initiated by a caller telecommunications device and established over a first communication channel;
receiving caller information that is associated with the caller telecommunications device and transmitted over a second communication channel;
selecting an information set from a plurality of information sets to send to the caller telecommunications device based on the caller information; and
sending the selected information set to a server over a third communication channel, the server storing the selected information in a directory accessible to the caller telecommunications device.

14. The method of claim 13 wherein the selection of the information set is based on historical caller information.

15. The method of claim 13 wherein the caller information comprises at least a portion of a telephone number for the caller telecommunications device.

16. The method of claim 13 wherein the communication initiated by the caller telecommunications device and established over the first communication channel is a voice communication.

17. A method for automatic execution of a task on a caller telecommunications device, the method comprising:
transmitting an information set from a called telecommunications device over a first communication channel to the caller telecommunications device, the caller telecommunications device being in communication with the called telecommunications device over a second communication channel;
receiving the transmitted information set at the caller telecommunications device; and
initiating a task on the caller telecommunications device in response to the transmitted information set.

18. The method of claim 17 wherein the task comprises execution of an application resident on the caller telecommunications device.

19. The method of claim 17 wherein the task comprises generating a request to an information service over a third communication channel.

20. The method of claim 17 wherein the caller telecommunications device is in voice communication with the called telecommunications device over the second communication channel.

21. The method of claim 19 wherein the third communication channel comprises an Internet communication channel.
